(19) United States
(12) Patent Application Publication
(10) Pub. No.: US 2007/0234030 A1
(43) Pub. Date: Oct. 4, 2007

(54) Controller interface ownership changing system and method

(75) Inventor: Ying-Chih Lu, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/396,094

(22) Filed: Mar. 31, 2006

(51) Int. Cl. G06F 9/00

(52) U.S. Cl. 713/2

(57) ABSTRACT

A controller interface ownership changing system and method are applicable to a basic input/output system (BIOS) of a data processing device having an operating system. The method actuates a first controller interface ownership changing mechanism to actuate system management interrupt (SMI) of a first controller interface controller when the BIOS is executing a power-on self test (POST), judges if SMI of a second controller interface is actuated through the SMI of the first controller interface after the POST is finished and when the operating system (OS) is installing, checks an ownership changing mechanism of the OS or a driver program of the second controller interface is actuated when actuated, disables the first controller interface and the SMI of the first controller interface in accordance with judging and checking results, and enables the driver program of the first controller of the OS to control the first controller, so as to change the ownerships of the controller interfaces between the BIOS and the OS.

### BACKGROUND OF THE INVENTION

1. Field of the Invention

This invention relates to data processing techniques, and more particularly, to a controller interface ownership changing system and method applicable to a basic input/output system.

2. Description of Related Art

With the development of information technologies, varieties of peripheral devices for providing a variety of functionalities to data processing devices such as personal computers and notebook computers are brought to the market. These data processing devices comprises data transmission ports for connecting to the peripheral devices. A universal serial bus (USB) is one of the most popular standards. USB 1.1 and USB 2.0 are two main-streamed USBs. Since USB 2.0 has a data transmission rate forty time faster than that of USB 1.1, peripheral devices adopting USB 2.0 standard have substituted for peripheral devices adopting USB 1.1 standard. Accordingly, main board manufactures provide main boards having data transmission ports supporting USB 2.0 standard.

To control the data transmission ports of USB 2.0, the main boards are provided with chip sets (i.e. SB ICH5R manufactured by Intel) for controlling USB data transmission ports. The chip sets support universal host controller interface (UHCI) 1.1 and enhanced host controller interface (EHCI) 2.0, and comprise four UCHI controllers for supporting eight USB 1.1 data transmission ports and an EHCI controller for supporting a USB 2.0 data transmission port. The EHCI controller supports a “USB 2.0 ownership changing mechanism”, which is used for changing an ownership of the USB 2.0 controller from BIOS to an operating system (OS).

The EHCI controller comprises two bits, that are EHCI OS control flag (Owned Semaphore) and EHCI BIOS control flag, for indicating that the EHCI controller is currently controlled by OS or BIOS. The EHCI controller further comprises an “EHCI ownership change” bit. When the OS writes “1” to the bit through an EHCI driver program, a system management interrupt (SMI) is generated. An SMI handler program corresponding to the SMI stops the EHCI controller controlled by the BIOS and disables the EHCI SMI, and sets the EHCI OS control flag to be “1” and the EHCI BIOS control flag to be “0”.

In practice, the USB 2.0 ownership changing mechanism from the BIOS to the OS comprises four steps:

Firstly, when the BIOS initials the EHCI controller and controls the EHCI controller in SMI manner (which is called legacy USB support, SMI of the EHCI controller is enabled, the SMI is periodic and happens one time a micro second) in a power-on self test (POST) process, the BIOS sets the EHCI OS control flag to be “0”, for indicating that the EHCI is controlled by the BIOS currently.

Secondly, in a process of actuating or initializing the OS, the OS writes “1” to the “EHCI controller ownership change” through the EHCI driver program, to generate an SMI to call the BIOS to return the ownership of the EHCI to the OS. The SMI handler program then stops the EHCI controller controlled by the BIOS and disables the SMI of the EHCI controller, and sets the EHCI OS control flag to be “1” and the EHCI BIOS control flag to be “0”.

Then the OS will wait until the EHCI OS control flag is changed to be “1”, for indicating that the EHCI is controlled by the OS currently.

Lastly, when the EHCI OS control flag is changed to be “1”, the OS will drive the EHCI OS control flag through the driver program of the EHCI controller to control the EHCI controller.

As described previously, not all of the operating systems support the EHCI controller changing mechanism. For example, Linux supports this function, and can therefore give the ownership to the OS. Accordingly, the EHCI controller can function normally, and the OS can be actuated and installed normally.

However, some Oss, such as Windows 2000 and 2300, do not support the ECHI controller ownership changing mechanism, and can not give the ECHI controller to the OS. Accordingly, the OS can not be actuated and installed (the system will pause in a “Staring Windows . . . ” state).

Two methods provided by BIOS designers are brought to the market to solve the above problems. One is to stop the EHCI controller and disable the SMI of the EHCI controller when an advanced configuration and power interface (ACPI) actuates SMI. Such the method can solve ACPI modes of Windows 2003/2000 only, and is not applicable to standard PCs of Windows 2003/2000 and multi processor specification (MPS) mode. The other one is to add a BIOS setting selection item to actuate/disable the “EHCI controller ownership change”. However, such the method, for users of Linux OS, has to select actuated, while users of Windows 2003/2000 have to select disabled. It is inconvenient for the users to switch if using different OSs.

In summary, how to provide a method for changing ownerships of different data transmission ports between BIOS and OS is becoming one of the most urgent errands in the art.

### SUMMARY OF THE INVENTION

In views of the above-mentioned problems of the prior art, it is a primary objective of the present invention to provide a controller interface ownership changing system and method for changing ownerships of different data transmission ports between a basic input/output system (BIOS) and an operating system (OS).

To achieve the above-mentioned and other objectives, a controller interface ownership changing system and method are provided according to the present invention. The controller interface ownership changing system is applicable to a basic input/output system of a data processing device having an operating system. The system includes a driving module for actuating a ownership changing mechanism of a first controller interface of the basic input/output system to actuate system management interface (SMI) of a first controller interface controller when the basic input/output system is executing a power-on self test (POST); a judging module for judging if SMI of a second controller interface is actuated through the SMI of the first controller interface, during the installing of operating system after the POST is finished; a checking module for checking if a ownership changing mechanism of the operating system or a driver program of the second controller interface is actuated when the SMI of the second controller interface is actuated; and

a changing module for disabling the SMI of the first controller interface when the SMI of the second controller interface is checked to be disabled or the ownership changing mechanism of the operating system is actuated, and disabling the SMI of the second controller interface when the driver program of the second controller interface is checked to be actuated.

The controller interface ownership changing method is also applicable to a basic input/output system of a data processing device having an operating system, the method includes (1) actuating a first controller interface ownership changing mechanism of the basic input/output system to actuate SMI of a first controller interface controller when the basic input/output system is executing a power-on self test (POST); (2) during the installing of the operating system after the POST is finished , judging if SMI of a second controller interface is actuated, if yes, go to step (3), or go to step (6); (3) checking if an ownership changing mechanism of the operating system is actuated, if yes, go to step (4), or go to step (7) ; (4) disabling the SMI of the first controller interface and proceeding to step (5); (5) enabling a driver program of the operating system to control the first controller interface controller and ending flow step; (6) disabling the SMI of the first controller interface and proceeding to step (5) ; and (7) after the driver program of the second controller is checked to be actuated, disabling the SMI of the second controller interface and returning to step (2).

Compared with the prior art, the controller interface ownership changing system and method of the present invention make the use of the interacting operations between the driving module, the judging module, the checking module and the changing module to transform the ownerships of different data transmission ports between the BIOS and the OS.

### BRIEF DESCRIPTION OF DRAWINGS

The invention can be more fully understood by reading the following detailed description of the preferred embodiments, with reference made to the accompanying drawings, wherein:

FIG. 1 is a functional block diagram of a data processing device having a controller interface ownership changing system of the preferred embodiment according to the present invention; and

FIG. 2 is a controller interface ownership changing method corresponding to the system shown in FIG. 1.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

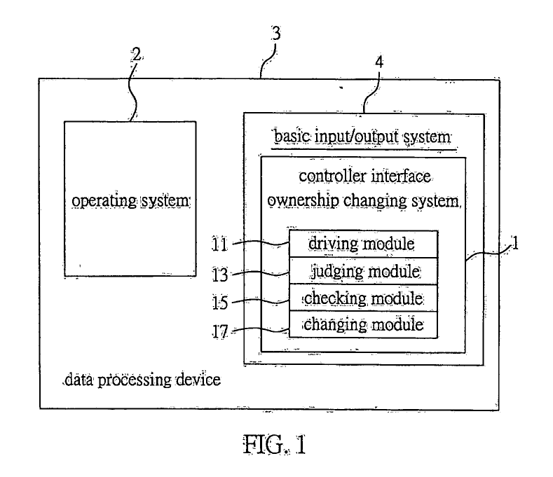

FIG. 1 is a functional block diagram of a data processing device 3 having a controller interface ownership changing system 1 of the preferred embodiment according to the present invention. The data processing device 3 comprises an operating system (OS) 2 and a basic input/output system (BIOS) in which the controller interface ownership changing system 1 is installed.

The controller interface ownership changing system 1 comprises a driving module 11, a judging module 13, a checking module 15 and a changing module 17. According to the preferred embodiment, the operating system 2 is Linux, Windows 2000 or Windows 2003, the data processing device 3 is a personal computer, a notebook computer or a server. The basic input/output system 4 is stored in a read only memory or a flash memory (not shown) installed on a main board (not shown) of the data processing device 3 for providing programs needed by the data processing device 3 and controlling the operations of a central processing unit, other chips and a variety of standard peripheral devices. When actuating the data processing device 3, the basic input/output system 4 first determines if all of the components in the data processing device 3 are functioning normally, and then loads the operating system 2 into a random access memory, so as to enable the operating system 2 to control the data processing device 3.

According to the preferred embodiment, the controller interface ownership changing system 1 is designed for the data processing device 3 to transform the ownerships of the USB 1.1 and USB 2.0 data transmission ports from the basic input/output system 4 to the operating system 2. Note that, the controller interface ownership changing system and method of the present invention are not limited to the transformation of the ownerships of the USB 1.1 and USB 2.0 data transmission ports, but can be used to transform the ownerships of peripheral devices from the basic input/output system to the operating system.

The driving module 11 is used for actuating an ownership changing mechanism of a first controller interface of the basic input/output system 4 to actuate SMI of a fist controller interface controller when the basic input/output system 4 is executing a power-on self test (POST). According to the preferred embodiment, the first controller interface is an enhanced host controller interface (EHCI) 2.0 having a first controller interface (EHCI) controller for supporting the USB 2.0 data transmission port of the data processing device 3 and changing the ownership of the USB 2.0 controller from the basic input/output system 4 to the operating system 2.

The judging module 13 is used to judge whether the SMI of a second controller interface is actuated through the SMI of the first controller interface when the POST is complete and the operating system 2 is installing. According to the preferred embodiment, the second controller interface is a universal host controller interface (UHCI) 1.1 having four second controller interface (UHCD controllers for supporting eight USB 1.1 data transmission ports, and changing the ownership of the USB 1.1 controller from the basic input/output system 4 to the operating system 2.

The checking module 15 is used for checking a ownership changing mechanism of the second controller interface or whether a driver program of the second controller interface is actuated after the SMI of the second controller interface is actuated. According to the preferred embodiment, if the operating system 2 is Linux, because Linux supports the ECHI controller changing mechanism, the ownership of the second controller interface can be changed to the operating system 2, the EHCI controller can function normally, and the operating system 2 can be actuated and installed normally. Therefore, if the operating system 2 is Linux, the checking module 15 checks if the ownership changing mechanism of the operating system 2 is actuated.

On the other hand, if the operating system 2 is Windows 2000 or Windows 2003, because neither Windows 2000 nor Windows 2003 supports the ECHI controller changing mechanism, the checking module 15 determines that the ownership changing mechanism of the operating system 2 is not actuated. Then the checking module 15 further checks if the driver program of the second controller interface (UCHI) is actuated.

The changing module 17 is used for disabling the SMI of the first controller interface if the SMI of the second controller interface is checked to be disabled or the ownership changing mechanism of the operating system 2 is actuated, and disabling the SMI of the second controller interface if the driver program of the second controller interface is checked to be actuated.

As described previously, when the operating system 2 is Linux and the ownership changing mechanism of the operating system 2 is checked to be actuated, the changing module 17 disables the SMI of the first controller interface. On the other hand, if the operating system 2 is Windows 2000 or Windows 2003, the checking module 15, after checking the driver program of the second controller interface(UCHI) is actuated, disables the SMI of the first controller interface. Moreover, after the judging module 13 has judged that the driver program of the second controller interface if actuated, the changing module 17 disables the SMI of the first controller interface. When the SMI of the first controller is disabled, the driver program of the first controller of the OS will take the control of the first controller.

Note that the EHCI (USB2.0) controller is manufactured based on the UHCI (USB 1.1) controller. In other words, when a legacy support of the USB 1.1 (UHCI) (BIOS controls the UHCI with an SMI mechanism) is disabled by the driver program of the operating system, a legacy support (EHCI controller SMI) of the USB2.0(EHCI) should be disabled accordingly. Then the EHCI controller is changed from the basic input/output system 4 to the operating system 2, so as to solve the problem that both Windows 2000 and Windows 2003 can not support the ECHI controller changing mechanism.

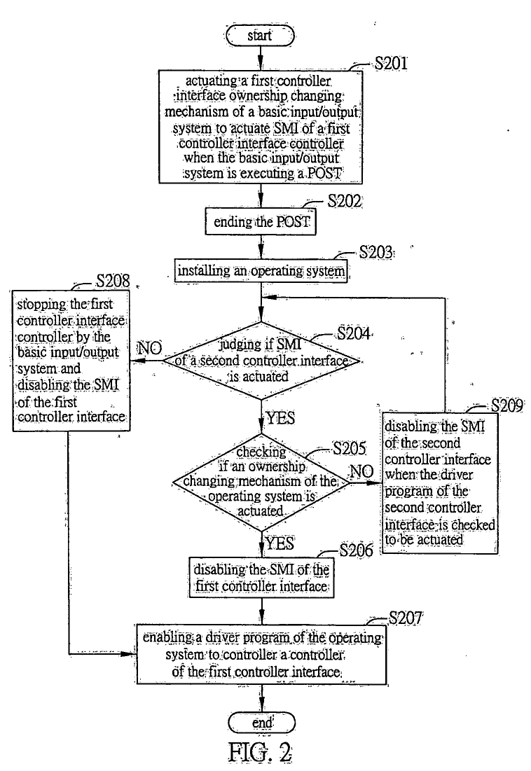

FIG. 2 is a flow chart of an controller interface ownership changing method through the use of the controller interface ownership changing system of the present invention. The method starts in step S210. In step S201, the ownership changing mechanism of the first controller interface of the basic input/output system is actuated to actuate the SMI of the first controller interface controller when the basic input/output system is executing the POST. The method then proceeds to step S202.

In step S202, the POST of the basic input/output system is finished. The method then proceeds to step S203.

In step S203, a process to install the operating system is entered. The method then proceeds to step S204.

In step S204, a judge is made to determine if the SMI of the second controller interface is actuated through the use of the SMI of the first controller interface. If the SMI of the second controller interface is actuated, the method proceeds to step S205, or the method proceeds to step S208.

In step S205, a check is made to judge if the ownership changing mechanism of the operating system is actuated. If yes, go to step S206, or go to step S209.

In step S206, the SMI of the first controller interface is disabled. Proceed to step S207.

In step S207, the driver program of the operating system is enabled to control the controller of the first controller interface.

In step S208, the first controller interface, which is controlled by the basic input/output system, is stopped so as to disable the SMI of the first controller interface. The method then proceeds to step S207.

In step S209, the SMI of the second controller interface is disabled when the driver program of the second controller interface is checked to be actuated. The method returns to step S204.

In summary, the controller interface ownership changing system and method of the present invention make the use of the interacting operations between the driving module, the judging module, the checking module and the changing module to transform the ownerships of different data transmission ports between the BIOS and the OS.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. An controller interface ownership changing system applicable to a basic input/output system of a data processing device having an operating system, the system comprising:
a driving module for actuating a ownership changing mechanism of a first controller interface of the basic input/output system to actuate system management interface (SMI) of a first controller interface controller when the basic input/output system is executing a power-on self test (POST);
a judging module for judging if SMI of a second controller interface is actuated through the SMI of the first controller interface during installing of the operating system after the POST is finished;
a checking module for checking if a ownership changing mechanism of the operating system or a driver program of the second controller interface is actuated when the SMI of the second controller interface is actuated; and
a changing module for disabling the SMI of the first controller interface when the SMI of the second controller interface is checked to be disabled or the ownership changing mechanism of the operating system is actuated, and disabling the SMI of the second controller interface when the driver program of the second controller interface is checked to be actuated.

2. The controller interface ownership changing system of claim 1, wherein the first controller interface is an enhanced host controller interface (EHCI)2.0 and comprises a first controller interface (EHCI) controller for supporting USB 2.0 data transmission ports of the data processing device, and changing ownership of the USB 2.0 controller from the basic input/output system to the operating system.

3. The controller interface ownership changing system of claim 1, wherein the second controller interface is a universal host controller interface (UHCI)1.1, and comprises four second controller interface (UCHI) controller for supporting eight USB 1.1 data transmission ports, and changing ownership of the USB 1.1 controller from the basic input/output system to the operating system.

4. The controller interface ownership changing system of claim 1, wherein the operating system is one selected from the group consisting of Linux, Windows 2000 and Windows 2003.

5. An controller interface ownership changing method applicable to a basic input/output system of a data processing device having an operating system, the method comprising:
(1) actuating a first controller interface ownership changing mechanism of the basic input/output system to actuate SMI of a first controller interface controller when the basic input/output system is executing a power-on self test (POST);
(2) during installing of the operating system after the POST is finished, judging if SMI of a second controller interface is actuated, if yes, go to step (3), or go to step (6);
(3) checking if an ownership changing mechanism of the operating system is actuated, if yes, go to step (4), or go to step (7) ;
(4) disabling the SMI of the first controller interface and proceeding to step(5);
(5) enabling a driver program of the operating system to control the first controller interface controller and ending flow step;
(6) disabling the SMI of the first controller interface and proceeding to step (5) ;and
(7) after the driver program of the second controller is checked to be actuated, disabling the SMI of the second controller interface and returning to step (2).

6. The controller interface ownership changing method of claim 5, wherein the first controller interface is an EHCI 2.0 and comprises a first controller interface (EHCI) controller for supporting a USB 2.0 data transmission port of the data processing device, and changing an ownership of the USB 2.0 controller from the basic input/output system to the operating system.

7. The controller interface ownership changing method of claim 5, wherein the second controller interface is a UHCI 1.1 and comprises four second controller interface (UCHI) controller for supporting eight USB 1.1 data transmission ports, and changing an ownership of the USB 1.1 controller from the basic input/output system to the operating system.

8. The controller interface ownership changing method of claim 5, wherein the operating system is one selected from the group consisting of Linux, Windows 2000 and Windows 2003.
